(19) United States
(12) Patent Application Publication
(10) Pub. No.: US 2019/0128147 A1
(43) Pub. Date: May 2, 2019

(54) WASTE HEAT RECOVERY SYSTEM WITH PARALLEL EVAPORATORS AND METHOD OF OPERATING

(71) Applicant: BorgWarner Inc., Auburn Hills, MI (US)

(72) Inventors: Xiaobing LIU, Auburn Hills, MI (US); John SHUTTY, Clarkston, MI (US)

(21) Appl. No.: 16/309,719

(22) PCT Filed: Jun. 9, 2017
(86) PCT No.: PCT/US2017/036694

§ 371 Date: Dec. 13, 2018

Related U.S. Application Data
(60) Provisional application No. 62/349,768, filed on Jun. 14, 2016.

(51) Int. Cl. F01K 23/06; F01K 13/02; F01K 23/10; F02G 5/04

(52) U.S. Cl. CPC F01K 23/065; F02G 5/04; F01K 23/101; F01K 13/02

(57) ABSTRACT

A control system for a vehicle comprises a controller (114), with the controller (114) further including a processor and a memory. The memory stores instructions executable by the processor such that the controller is programmed to detect a temperature difference (ΔT_{Evap}), select a flow ratio, and select a valve opening setting (242, 244, 250, 252, 258, 260). The difference in temperature (ΔT_{Evap}) is between a working fluid (15) downstream of a first evaporator (16) and a working fluid (15) downstream of a second evaporator (20). The flow ratio is a desired flow ratio based on the difference in temperature (ΔT_{Evap}). The valve opening setting (242, 244, 250, 252, 258, 260) for each of a first valve (84) regulating flow of the working fluid into the first evaporator (16) and a second valve (86) regulating flow of the working fluid into the second evaporator (20) based on the flow ratio.

### BACKGROUND

An estimated twenty percent to fifty percent of fuel energy is lost as waste heat in the operation of typical internal combustion engines of the type used in vehicles. Waste heat recovery systems transform what would otherwise be wasted heat energy into more useful energy including mechanical energy and electrical energy. One known technique for waste heat recovery exploits the Rankine thermodynamic cycle, with an organic, high molecular mass fluid having a boiling point lower than the boiling point of water. The resultant thermodynamic cycle is known as an Organic Rankine Cycle.

### BRIEF DESCRIPTION OF THE DRAWINGS

FIG. 1 is a schematic diagram of an example waste heat recovery system for an internal combustion engine.

FIG. 2 is a schematic diagram of example control system for the waste heat recovery system of FIG. 1.

FIG. 3 is a schematic diagram of an example temperature control logic subsystem of the waste heat recovery system of FIGS. 1 and 2.

FIG. 4 is a schematic diagram of an example temperature difference control logic subsystem of the waste heat recovery system of FIGS. 1 and 2.

FIG. 5 is a graph illustrating an exemplary lag in exhaust gas recirculation (“EGR”) relative to fresh air flow responsive to opening and closing an EGR valve or closing an intake throttle.

FIG. 6 is a graph illustrating valve management and pump management and temperature management of a first control system responsive to step changes in EGR.

FIG. 7 is a graph illustrating valve management and pump management and temperature management of a second control system responsive to step changes in EGR.

FIG. 8 is a graph illustrating valve management and pump management and temperature management of a third control system responsive to step changes in EGR.

FIG. 9 is a graph illustrating a first exemplary valve opening to flow ratio relationship.

FIG. 10 is a graph illustrating a second exemplary valve opening to flow ratio relationship.

FIG. 11 is a graph illustrating a third exemplary valve opening to flow ratio relationship.

### DETAILED DESCRIPTION

### Introduction

It is desired to provide a responsive and stable control system for a waste heat recovery system for extracting waste heat from internal combustion engines. It is further desired to maintain a working fluid of such a waste heat recovery system within a predetermined temperature range. It is yet further desired to eliminate instrumentation-dependent data time lags that may result in processing discontinuities.

An exemplary system includes a vehicle control system that comprises a controller, with the controller further including a processor and a memory. The memory stores instructions executable by the processor such that the controller is programmed to detect a temperature difference, select a flow ratio, and select a valve opening setting. The difference in temperature is between a working fluid downstream of a first evaporator and a working fluid downstream of a second evaporator. The flow ratio is a desired flow ratio based on the difference in temperature. The valve opening setting for each of a first valve regulating flow of the working fluid into the first evaporator and a second valve regulating flow of the working fluid into the second evaporator based on the flow ratio.

Relative orientations and directions (by way of example, higher, lower, upstream, downstream) are set forth in this description not as limitations, but for the convenience of the reader in picturing at least one embodiment of the structures described.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

### Exemplary System Elements

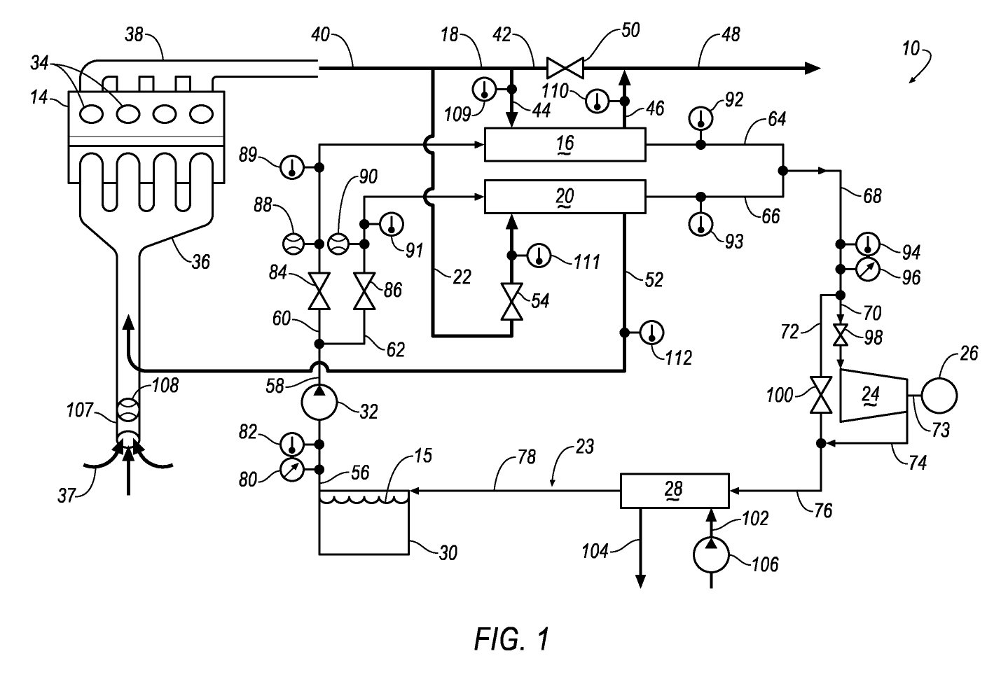

An exemplary waste heat recovery system 10 is illustrated in FIG. 1. Waste heat recovery system 10 recovers heat from the exhaust gas of an internal combustion engine 14. Heat is recovered by circulating a working fluid 15 through a first or exhaust gas evaporator, alternatively characterized as a tailpipe evaporator 16 that extracts heat from exhaust gas passing through a first tailpipe conduit 18. Heat is also recovered by circulating the working fluid 15 through a second or EGR evaporator 20 that extracts heat from exhaust gas passing through an exhaust gas recirculation (“EGR”) evaporator inlet conduit 22. Evaporators 16 and 20 may alternatively be characterized as fluid-to-fluid heat exchangers. Such fluid-to-fluid heat exchangers are suited to having air or exhaust gas on one side of a heat-exchange surface (not shown) and working fluid 15, in both liquid form and gas form, on an opposed side of the heat-exchange surface.

Waste heat recovery system 10 further includes an energy recovery circuit 23 comprising the portion of the waste heat recovery system 10 through which the working fluid 15 passes. Energy recovery circuit 23 includes tailpipe evaporator 16, EGR evaporator 20, a turbine 24, a generator 26 driven by turbine 24, a condenser 28, a tank 30 for liquefied working fluid 15, and a pump 32 for pumping liquid working fluid 15. Exemplary working fluid 15 may be a high molecular mass fluid having, at a specific atmospheric pressure, a boiling point less than the boiling point of water for such atmospheric pressure. Exemplary working fluids 15 include but are not limited to ammonia, ethanol alcohol, and chlorofluorocarbons (“CFRs”) such as R11 and R134a, and R236a. The working fluid is in at least a partially liquid state when it reaches evaporators 16 and 20.

Internal combustion engine 14 has a plurality, four in the exemplary illustration of FIG. 1, of combustion chambers 34. An intake manifold 36, alternatively an intake header, generically characterized as intake manifold 36 herein, communicates a combination of fresh air drawn from the surrounding atmosphere and fuel to the combustion chambers 34. Recirculated exhaust gas may be selectively communicated to the combustion chambers 34 through the intake manifold 36. Exhaust gas from combustion chambers 34 is communicated by engine 14 to an exhaust manifold 38 or exhaust header, generically characterized as exhaust manifold 38 herein. The exhaust gas is communicated in turn from exhaust manifold 38 to exhaust gas conduit 40.

The exhaust gas from conduit 40 may be split between communication to EGR evaporator inlet conduit 22 and tailpipe conduit 18. Exhaust gas passing through tailpipe conduit 18 is selectively divided between a bypass conduit 42 and an inlet conduit 44 to tailpipe evaporator 16. Exhaust gas passing through inlet conduit 44 passes through tailpipe evaporator 16 and through outlet conduit 46 to a tailpipe 48. Bypass conduit 42 connects to and communicates exhaust gas to tailpipe 48. Exhaust gas that passes through bypass conduit 42 may be selectively restricted or selectively entirely blocked by a bypass valve 50 disposed in conduit 42. Tailpipe 48 directs the exhaust gas received from conduits 42 and 46 to the atmosphere, i.e., the environment external to a vehicle. Exhaust treatment components not expressly included herein, including by way of example catalytic converters and exhaust reformers, may be selectively included.

Exhaust gas communicated to EGR evaporator inlet conduit 22 moves to EGR evaporator 20 and out through an EGR evaporator outlet conduit 52. Outlet conduit 52 connects to intake manifold 36, communicating exhaust gas from evaporator 20 to intake manifold 36. A valve 54 disposed in conduit 22 selectively restricts or entirely blocks the flow of exhaust gas from exhaust manifold 38 to EGR evaporator 20.

Circuit 23 includes additional conduit elements for communicating working fluid 15. Working fluid 15 is drawn through a working fluid pump inlet conduit 56 by pump 32. A working fluid pump outlet conduit 58 is connected to pump 32 and receives fluid therefrom. Conduit 58 connects to tailpipe evaporator working fluid inlet conduit 60 and EGR evaporator working fluid inlet conduit 62, with fluid from conduit 58 selectively being split between conduits 60 and 62. Fluid that enters conduit 60 passes into and through one or more expansion channels (not shown) of tailpipe evaporator 16, and on to tailpipe evaporator working fluid outlet conduit 64. Fluid that enters conduit 62 passes into and through one or more expansion channels (not shown) of EGR evaporator 20, and on to EGR evaporator working fluid outlet conduit 66. Working fluid 15 does not directly contact exhaust gas in either of evaporators 16 and 20. Both outlet conduits 64 and 66 communicate fluid 15 to a blended working fluid conduit 68. Conduit 68 splits into a turbine supply conduit 70 and a turbine bypass conduit 72, with working fluid selectively distributed between the two conduits 70 and 72. Fluid from conduit 70 passes through turbine 24, with the fluid 15 in a gaseous state, that is, completely vaporized, and acts against turbine blades (not illustrated) in a well-known manner and induces rotation of a turbine shaft 73 to transfer energy to the exemplary generator 26. Turbine 24 may be damaged if fluid 15 is not completely in a gaseous state when it enters turbine 24. Generator 26 transforms the mechanical power developed by turbine 24 into electrical power. Alternatively, shaft 73 may be connected to another device for alternative power transfers. One such alternative arrangement connects shaft 73 to a drive shaft of engine 14. Yet further alternatively, a reciprocating piston, or a scroll-type expander, may be used in place of turbine 24 to expand working fluid 15 and convert such energy to mechanical energy to be transmitted by shaft 73. A turbine outlet conduit 74 communicates fluid 15 from turbine 24 to a condenser input conduit 76. Both conduit 74 and conduit 72 are connected to condenser input conduit 76. Conduit 76 connects to condenser 28. Condenser 28 has at least one fluid channel (not shown) receiving fluid from conduit 76. Fluid passes through condenser 28 into condenser output conduit 78 that communicates working fluid 15 in a substantially liquid form to tank 30.

Circuit 23 and the engine air intake and exhaust elements further include exemplary sensing and control elements. A pressure sensor 80 and a temperature sensor 82 may each be disposed along conduit 56 between tank 30 and pump 32. Selectively actuable valves 84 and 86 are disposed in conduits 60 and 62 respectively for selectively allocating or regulating the flow of working fluid 15 through conduits 60 and 62 and evaporators 16 and 20. Alternatively, a single one of the valves 84 and 86 can be used to distribute the flow of working fluid, so long as the evaporators associated with the valve will not need more than on half the available flow. Yet alternatively, a diverter valve (not shown) can be disposed at a junction of conduits 60 and 62, selectively allocating or regulating the flow of the working fluid between conduits 60 and 62 and evaporators 16 and 20. Each of conduits 60 and 62 may have a mass flow sensor, 88 and 90 respectively, disposed between the respective valves 84, 86 and evaporators 16, 20. Alternatively, flow rates through evaporators 16 and 20 may be estimated using the current speed of pump 32 and the setting of valves 84 and 86. Conduits 60 and 62 may also have temperature sensors 89 and 91 respectively to measure the temperatures of the working fluid 15 just prior to its entry to evaporators 16 and 20. Depending on the location of sensor 82 and the potential for intervening temperature changes, it may be possible to do without sensors 89 and 91 and instead rely on the temperature measurements of sensor 82. Each of conduits 64 and 66 has a temperature sensor 92 and 93 respectively to measure the temperatures of working fluid 15 in each of conduits 64 and 66 to measure the temperature of the working fluid 15 proximate to exits of evaporators 16 and 20 as working fluid 15 leaves evaporators 16 and 20. A single relative temperature sensor may be used as an alternative to temperature sensors 92 and 93 to determine a difference in temperatures between working fluid leaving evaporator 16 and working fluid leaving evaporator 20. A temperature sensor 94 and a pressure sensor 96 may each be disposed along conduit 68 to provide indications of the temperature and pressure of working fluid 15 in conduit 68. A selectively actuable turbine inlet valve 98 is disposed in conduit 70 for selective restriction of the flow of fluid 15 reaching turbine 24. A selectively actuable turbine bypass valve 100 may be disposed in conduit 72 for selective bypassing of turbine 24 by working fluid 15. Valve 98 may be closed and valve 100 may be opened if temperatures sensed by sensor 94 are indicative of working fluid 15 being in a partially liquid state. Condenser 28 receives coolant, such as engine coolant, through a condenser coolant inlet conduit 102. Condenser 28 includes at least one channel receiving coolant from conduit 102. Coolant that has passed through condenser 28 exits through outlet conduit 104 in a substantially liquid state. A condenser coolant pump 106 supplies coolant to condenser 28 through conduit 102. Tank 30 serves as a reservoir of cooling fluid 15 in a substantially liquid state.

An intake 107 for fresh air 37 is connected to intake manifold 36. A mass airflow sensor 108 may be disposed in intake manifold 36 for measuring a volumetric rate of fresh air entering manifold 36. Alternatively, a mass airflow sensor (not shown) may be disposed in conduit 52 to measure a volumetric rate of exhaust gas entering intake manifold 36. Temperature sensors 109, 110, 111, 112 may be located in the conduits leading into and out of evaporators 16 and 20 to facilitate calculations of the heat energy transferred from the exhaust gas passing through the evaporators. Temperature sensor 109 may be disposed in conduit 44 to measure the temperature of the exhaust gas entering tailpipe evaporator 16. Temperature sensor 110 may be disposed in conduit 46 to measure the temperature of the exhaust gas exiting tailpipe evaporator 16. Temperature sensor 111 may be disposed in conduit 22 to measure the temperature of the exhaust gas entering EGR evaporator 20. Temperature sensor 112 may be disposed in conduit 52 to measure the temperature of the exhaust gas exiting EGR evaporator 20.

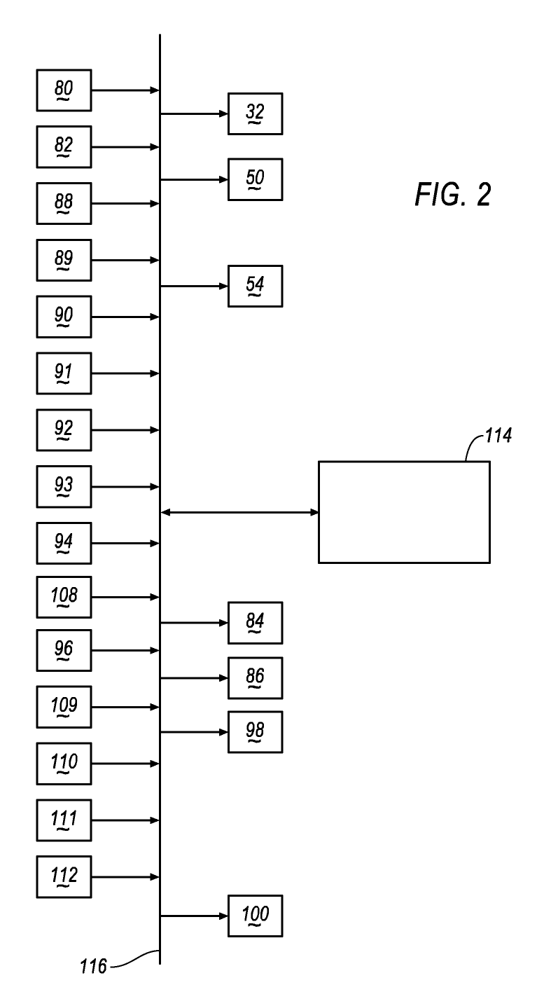

FIG. 2 provides an exemplary illustration of how control elements such as sensors and selectively actuable valves and pumps are connected. A controller 114 is electrically connected to, either directly or indirectly, and receives input signals from sensors including temperature sensors 82, 89, 92, 93, 94, 109, 110, 111, 112, pressure sensors 80, 96, and mass flow sensors 88, 90, 108. Controller 114 is also electrically connected to, either directly or indirectly, pump 32 and valves 50, 54, 84, 86, 98, 100, and sends signals thereto. Exemplary controller 114 is illustrated in FIG. 2 as making such electrical connections through an in-vehicle network such as is known, e.g., a controller area network (“CAN”) bus 116 or the like. Waste heat recovery system 10 responds to input from the sensors to actuate pump 32 and valves 50, 54, 84, 86, 98, 100. Exemplary waste heat recovery system 10 is disposed at least in part in controller 114, which may be alternative characterized as an electronic control unit (ECU) or a computer. Controller 114 includes at least one electronic processor and an associated memory. The memory includes one or more forms of computer-readable media, and stores instructions executable by the processor for performing various operations, including such operations as disclosed herein. The memory of controller 114 further generally stores remote data received via various communications mechanisms; i.e., controller 114 may be generally configured for communications on vehicle network such as an Ethernet network or the CAN bus 116 or the like, and/or for using other wired or wireless protocols, e.g., Bluetooth, etc.

### Processing

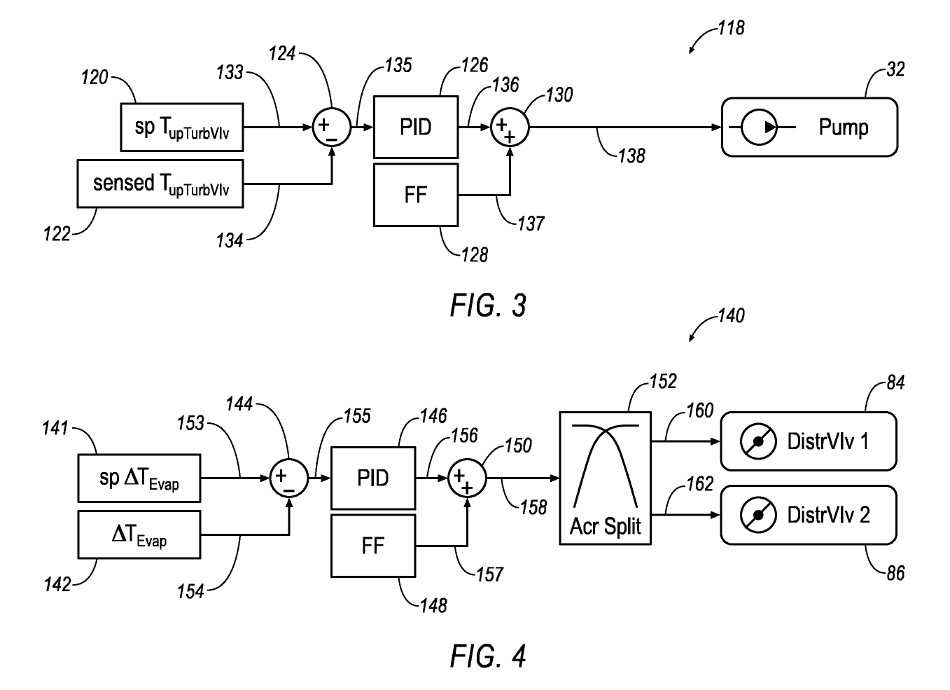

FIG. 3 illustrates a method incorporating an exemplary control logic subsystem 118 for managing a temperature of the working fluid 15 just before it enters turbine 24. When the expanding device is a high speed turbine, it is desired to ensure that the working fluid is completely vaporized before it enters the turbine to prevent any possible damage to the turbine. Accordingly, working fluid 15 is preferably at a temperature ensuring that fluid 15 is in a superheated state when it enters turbine 24. A maximum temperature of working fluid 15 should be less than a threshold of chemical decomposition of the working fluid. Subsystem 118 may include process block 120, process block 122, process block 124, process block 126, process block 128, and process block 130 to manage pump 32. Alternative expanders, potentially including reciprocating piston expanders and scroll-type expanders, may not require the working fluid to be completely vaporized.

Process block 120 establishes a reference or set point temperature that ensures the working fluid is at the desired target or set point temperature. Such a set point temperature is characterized in FIG. 3 as sp_T_{upTurbVlv}. Process block 122 detects a temperature of working fluid 15 upstream of turbine 24 where the working fluid exiting each of the evaporators has blended. Process block 122 uses input from a sensor proximate to an upstream or intake side of turbine 24, such as, by way of example, sensor 94, to establish a measured temperature upstream of turbine inlet valve 98, the measured temperature characterized in FIG. 3 as sensed_T_{upTurbVlv}. The turbine inlet valve 98 is closed until the sensed working fluid temperature sensed_T_{upTurbVlv} is superheated. During a handshake process which occurs when system 10 is activated, turbine bypass valve 100 gradually closes and turbine inlet valve 98 gradually opens. In normal operation, valve 98 is fully open to reduce pressure across valve 98. Turbine speed is controlled by the resistive load, such as that imposed by generator 26. If sensed_T_{upTurbVlv} or any working fluid temperature monitored exceeds the maximum temperature of the working fluid, the controller may interpret such temperature as an indicator of an operating limit of the waste heat recovery system 10 and open valve 50, particularly if pump 32 is already operating at its capacity. Opening valve 50 allows exhaust gas to bypass the waste heat recovery system 10, reducing a heat load on the system 10.

As an alternative to process block 122 providing sensed_T_{upTurbVlv} as input 134 to process block 124, process block 122 may provide a sensed maximum value among several sensed values. The sensed maximum value is a maximum temperature of among exemplary temperatures including sensed_T_{upTurbVlv}, (sensed_T_{downEGREvap}−T_{δ}), and (sensed_T_{downEGEvap}−T_{δ}). The “sensed_T” values are all sensed working fluid temperatures, with sensed_T_{upTurbVlv} being the temperature sensed by sensor 94, sensed_T_{downEGREvap} being the temperature sensed by sensor 93, and sensed_T_{downEGEvap} being the temperature sensed by sensor 92. The temperature T_{δ} is a calibration variable, with one exemplary value being 10° C. The value of T will depend on the characteristics of the system. Overly large values of T_{δ} may make control of temperature sensed_T_{upTurbVlv} (FIG. 3) and control of a “delta temperature”, discussed in more detail below, less coupled to each other. Delta temperature, alternatively characterized as ΔT_{Evap}, is distinct from T_{δ} and is discussed below in more detail in the context of FIG. 4. Larger values of T_{δ} allow temperature control targets for T_{upTurbVlv} unless sensed_T_{downEGEvap} or Sensed_T_{downEGREvap} is larger than sensed_T_{upTurbVlv} by the amount T_{δ}. A larger value of T_{δ} avoids frequent temperature control target switching among the three temperatures sensed_T_{upTurbVlv}, (sensed_T_{downEGREvap}−T_{δ}), and (sensed_T_{downEGEvap}−T_{δ}), and improves decoupling of the control of T_{upTurbVlv} and the control of ΔT_{Evap} results.

Process block 124 compares the values of inputs 133 and 134 provided by process blocks 120 and 122 respectively, subtracting input 134 from input 133 to determine a deviation of the sensed temperature from the set point, yielding an error temperature. The error temperature provided by process block 124 is an input 135 used by process block 126. Feedback process block 126 provides a feedback control signal in the form of input 136 for use by process block 130. Process block 126 is a proportional-integral-derivative (“PID”) control feedback function that may process input 135 to provide a control signal or input 136, correcting the mass flow rate \dot{m}_{WF}, to move input 134 closer in value to input 133. Such PID functions are well known. Feedforward process block 128 determines a target working fluid mass flow rate \dot{m}_{WF}, associated with a corresponding rotational speed of pump 32. The target flow rate and pump speed may be calculated based on a mathematical model of systems 10 and 12 and measurements from sensors including sensors 92 as well as sensors, not shown, for the temperature and mass flow rates of the engine exhaust gas through each of the evaporators 16, 20 and exhaust gas temperatures at the entry and exit points of each of evaporators 16, 20. A working fluid mass flow rate \dot{m}_{WF} may be targeted to achieve the desired set point temperature sp_T_{upTurbVlv}, using feedforward control methods employing the equation:

\dot{m}_{WF}=( [symbol] _{EGR}+ [symbol] _{EG})/(h_{WF}_{_}_{upTurbVlv}−h_{WF}_{_}_{upEvap}) Equation 1:

In equation 1, a rate of heat released by EGR exhaust gas is characterized as [symbol] _{EGR}, and a rate of heat released by non-EGR or tailpipe exhaust gas or more simply just “exhaust gas” is characterized as [symbol] _{EG}. The enthalpy of the working fluid before it enters the turbine is characterized as h_{WF}_{_}_{upTurbVlv} and the enthalpy of the working fluid before it enters either of the evaporators is characterized as h_{WF}_{_}_{upEvap}. Equation 1 may be derived as described further below.

The heat recovered by the working fluid is a function of the heat available from the exhaust gases. The rate of heat released by EGR exhaust gas, [symbol] _{EGR}, and the rate of heat released by non-EGR or tailpipe exhaust gas, [symbol] _{EG}, may be calculated as:

[symbol]

_{EGR}=Cp\dot{m}_{EGR}(T_{EGR}_{_}ᵤₚ−T_{EGR}_{_}_{down}) Equation 2 (EGR exhaust gas):

[symbol]

_{EG}=Cp\dot{m}_{EG}(T_{EG}_{_}ᵤₚ−T_{EG}_{_}_{down}) Equation 3 (Tailpipe (non-EGR) exhaust gas):

with Cp=Specific heat of the exhaust gas

\dot{m}_{EG}=mass flow rate of exhaust gas passing through tailpipe evaporator 16

\dot{m}_{EGR}=mass flow rate of exhaust gas passing through EGR evaporator 20

T_{EG}_{_}ᵤₚ=temperature of exhaust gas upstream of the tailpipe evaporator 16

T_{EG}_{_}_{down} temperature of exhaust gas downstream of the tailpipe evaporator 16

T_{EGR}_{_}ᵤₚ=temperature of exhaust gas upstream of the EGR evaporator 20

T_{EGR}_{_}_{down}=temperature of exhaust gas downstream of the EGR evaporator 20.

T_{EG}_{_}ᵤₚ may be measured by sensor 109. T_{EG}_{_}_{down} may be measured by sensor 110. T_{EGR}_{_}ᵤₚ may be measured by sensor 111. T_{EGR}_{_}_{down} may be measured by sensor 112.

Heat absorbed by the working fluid from the exhaust gas through the EGR evaporator 20 and the tailpipe evaporator 16, [symbol] _{WF}_{_}_{EGR} and [symbol] _{WF}_{_}_{EG} respectively, may be calculated as:

[symbol]

_{WF}_{_}_{EGR}=\dot{m}_{WF}_{_}_{EGR}(h_{WF}_{_}_{EGR}_{_}_{down}−h_{WF}_{_}_{EGR}_{_}ᵤₚ) Equation 4:

[symbol]

_{WF}_{_}_{EG}=\dot{m}_{WF}_{_}_{EG}(h_{WF}_{_}_{EG}_{_}_{down}−h_{WF}_{_}_{EG}_{_}ᵤₚ) Equation 5:

with \dot{m}_{WF}_{_}_{EGR} equal to the mass flow rate through the EGR evaporator 20, \dot{m}_{WF}_{_}_{EG} equal to the mass flow rate through the tailpipe evaporator 16, h_{WF}_{_}_{EGR}_{_}_{down} equal to the enthalpy of the working fluid downstream of the EGR evaporator, h_{WF}_{_}_{EGR}_{_}ᵤₚ equal to the enthalpy of the working fluid downstream of the EGR evaporator, h_{WF}_{_}_{EG}_{_}_{down} equal to the enthalpy of the working fluid downstream of the EGR evaporator, and h_{WF}_{_}_{EG}_{_}ᵤₚ equal to the enthalpy of the working fluid downstream of the EGR evaporator. The enthalpy values h_{WF}_{_}_{EGR}_{_}_{down}, h_{WF}_{_}_{EGR}_{_}ᵤₚ, h_{WF}_{_}_{EG}_{_}_{down}, and h_{WF}_{_}_{EG}_{_}ᵤₚ may be determined by temperature measurements from, respectively, temperature sensors 93, 91, 92, and 89.

A total of the mass flow rate of the working fluid \dot{m}_{WF} equals the sum of the mass flow rate through the EGR and tailpipe evaporators, characterized respectively as \dot{m}_{WF}_{_}_{EGR} and \dot{m}_{WF}_{_}_{EG}:

\dot{m}_{WF}=\dot{m}_{WF}_{_}_{EGR}+\dot{m}_{WF}_{_}_{EG} Equation 6:

An energy balance between the rate of energy removed from the exhaust gas and the rate of energy absorbed by the working fluid 15 at steady state may be expressed as:

( [symbol] _{EGR}+ [symbol] _{EG})*factor=( [symbol] _{WF}_{_}_{EGR}+ [symbol] _{WF}_{_}_{EG}) Equation 7:

where “factor” compensates for heat losses including heat losses due to the inefficiencies of the evaporators 16, 20, including but not limited to a loss of heat to the ambient environment.

A total of the collective rate of energy absorbed by the working fluid, [symbol] _{WF}, may be expressed as the sum of the rates of energy absorbed in both the tailpipe evaporator 16 and the EGR evaporator 20, [symbol] _{WF}_{_}_{EG} and [symbol] _{WF}_{_}_{EGR} respectively:

( [symbol] _{WF}_{_}_{EG}+ [symbol] _{WF}_{_}_{EGR})= [symbol] _{WF} Equation 8:

Assuming that the only significant heat transfer to or from the working fluid 15 occurs in the evaporators, the collective rate of energy absorbed by the working fluid, [symbol] _{WF}, may be characterized as equaling the mass flow rate \dot{m}_{WF} multiplied by a change in enthalpy from an enthalpy h_{WF}_{_}_{upEvap} characterized by a temperature measured by sensor 82 and an enthalpy h_{WF}_{_}_{upTurbVlv} characterized by a temperature measured by sensor 94:

[symbol]

_{WF}=\dot{m}_{WF}(h_{WF}_{_}_{upTurbVlv}−h_{WF}_{_}_{upEvap}) Equation 9:

Substituting equations 8 and 9 into equation 7 and solving for mass flow rate as a function of working fluid enthalpy, which in turn is a function of working fluid temperature, yields the above Equation 1:

\dot{m}_{WF}=factor*( [symbol] _{EGR}+ [symbol] _{EG})/(h_{WF}_{_}_{upTurbVlv}−h_{WF}_{_}_{upEvap})

The pump speed required to achieve the calculated flow, and thus achieve the desired temperature at sensor 94, may be calculated using a pump characteristic curve. Such a value may be a significant component of the feedforward operator 128 and input 137. The values of feedforward input 137 and feedback input 136 are combined in operator 130 to generate a control signal for pump 32 in the form of an input 138 directed to pump 32.

An exemplary delta temperature control includes a feedforward control and a corrective feedback control as shown in FIG. 4. The feedback control can be a PID control. The measured delta temperature is regulated by adjusting the openings of the two distribution valves 84 and 86 upstream of evaporators 16 and 20 respectively. The feedforward control is established to obtain a target delta temperature and is based at least in part on the following equation: Heat transfer ratio=100*(heat transfer from EGR gas)/(heat transfer from EGR gas+heat transfer from exhaust gas).

The heat transfer rate for EGR and EG exhaust gas is calculated as Equations 2 and 3, repeated below:

[symbol]

_{EGR}=Cp\dot{m}_{EGR}(T_{EGR}_{_}ᵤₚ−T_{EGR}_{_}_{down}) Equation 2:

[symbol]

_{EG}=Cp\dot{m}_{EG}(T_{EG}_{_}ᵤₚ−T_{EG}_{_}_{down}) Equation 3:

The heat flow ratio Hx is calculated using the above values to reach the below equation:

Hx=100* [symbol] _{EGR}/( [symbol] _{EGR}+ [symbol] _{EG}) Equation 10:

with Hx having a value between 0 and 100.
Given the value determined by Equation 10, and Equation 7 (( [symbol] _{EGR}+ [symbol] _{EG})*factor=( [symbol] _{WF}_{_}_{EGR}± [symbol] _{WF}_{_}_{EG})), a mathematical relationship is established between heat flow ratio Hx and the delta T of the working fluid exiting the evaporators.

FIG. 4 illustrates a method incorporating an exemplary control logic subsystem 140 for managing the difference in temperatures between a temperature of working fluid 15 exiting evaporator 16 and a temperature of working fluid 15 exiting evaporator 20. One possible value for the temperature difference, or delta temperature, is zero. The actual or measured working fluid delta temperature may be established by comparing the temperature measurements provided by temperature sensors 92 and 93. The value of zero for a delta temperature has been determined in the course of developing the method and system described herein to provide a stable temperature at the turbine inlet. However, alternative values, such as, by way of example and not limited to, −10 and +10 on a relevant temperature scale, may also be employed. Subsystem 140 may include process block 141, process block 142, process block 144, process block 146, process block 148, process block 150, and process block 152 to manage valves 84 and 86.

Process block 141 establishes a set point delta temperature, characterized in FIG. 4 as spΔT_{Evap}, to better allow the temperature T_{upTurbVlv} of the working fluid 15 entering the turbine. The set point delta temperature, spΔT_{Evap}, may be set equal to zero. Process block 142 determines a difference in temperature between a temperature of the working fluid downstream of evaporator 16 and a temperature of the working fluid downstream of evaporator 20. Process block 142 may use input of measured temperatures from sensors 92 and 93 to establish the temperature difference therebetween, characterized as the delta temperature of the working fluid 15 leaving evaporators 16 and 20, and characterized in FIG. 4 as ΔT_{Evap}. Process block 144 performs the function of comparing the values of inputs 153 and 154 provided by process blocks 141 and 142 respectively, subtracting input 154 from input 153 to determine a deviation of the sensed delta temperature from the set point (spΔT_{Evap}−ΔT_{Evap}) or a delta error temperature. The delta error temperature provided by process block 144 is an input 155 used by feedback process block 146. Feedback process block 146 provides a feedback control signal in the form of input 156 for use by process block 150. Process block 146 may be characterized as a PID control feedback function that processes input 155 to provide a error-correcting feedback signal or input 156 that is combined by process block 150 with a feedforward input signal 157 provided by feedforward process block 148.

One exemplary logic arrangement includes process block 148 using equation 10 to establish a feedforward value of the heat flow ratio Hx. Process block 148 may use the mass flow rates of exhaust gases through evaporators 16 and 20, as established by measurements provided by sensor 108 and the below-described calculations, and the measured temperatures from temperature sensors including sensors 109 and 111 to establish target values for temperatures of the exhaust gases exiting evaporators 16 and 20 as may be measured by sensors 110 and 112 that are compatible with the delta temperature being zero. Alternatively, by way of example, exhaust mass flow sensors may be located in other locations including conduit 52, conduit 40, conduit 44, and conduit 22.

Process block 150 sums the input 156 from the PID controller and the input 157 from the FF controller to provide an input 158 for process block 152. In process block 152, based on steady state test data, or simulation, or modeling, controller 114 translates the corrected value of Hx provided by input 158 into valve opening position settings for valves 84 and 86 using output curve maps for the two distribution valves 84 and 86. Process block 152 provides input 160 to valve 84 and input 162 to valve 86, selectively actuating each of valves 84 and 86 responsive to the delta temperature.

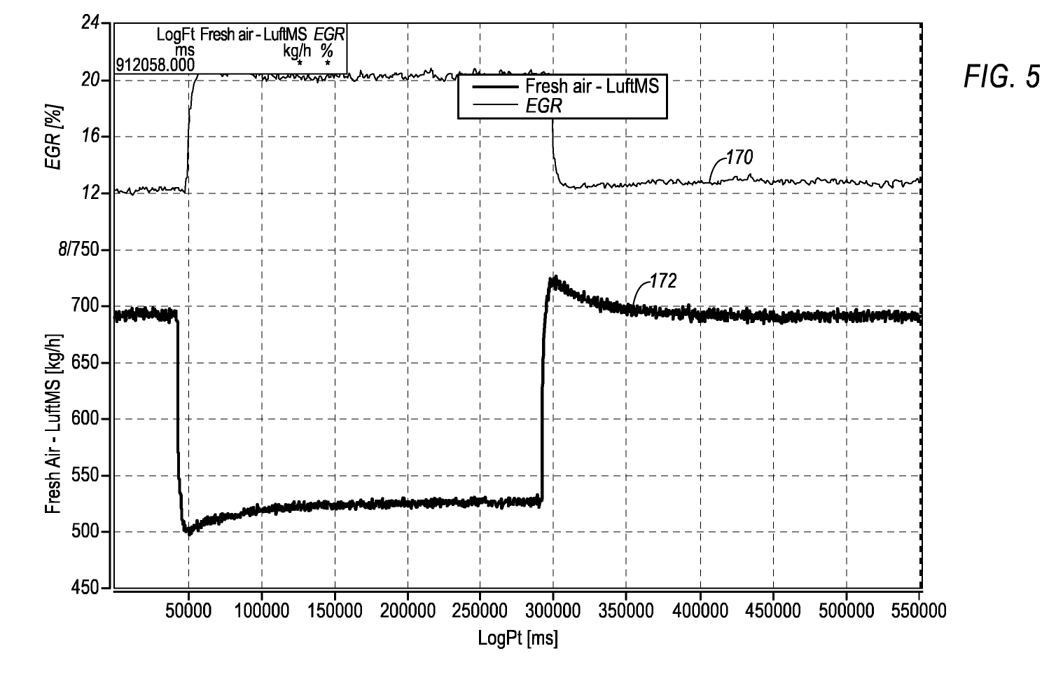

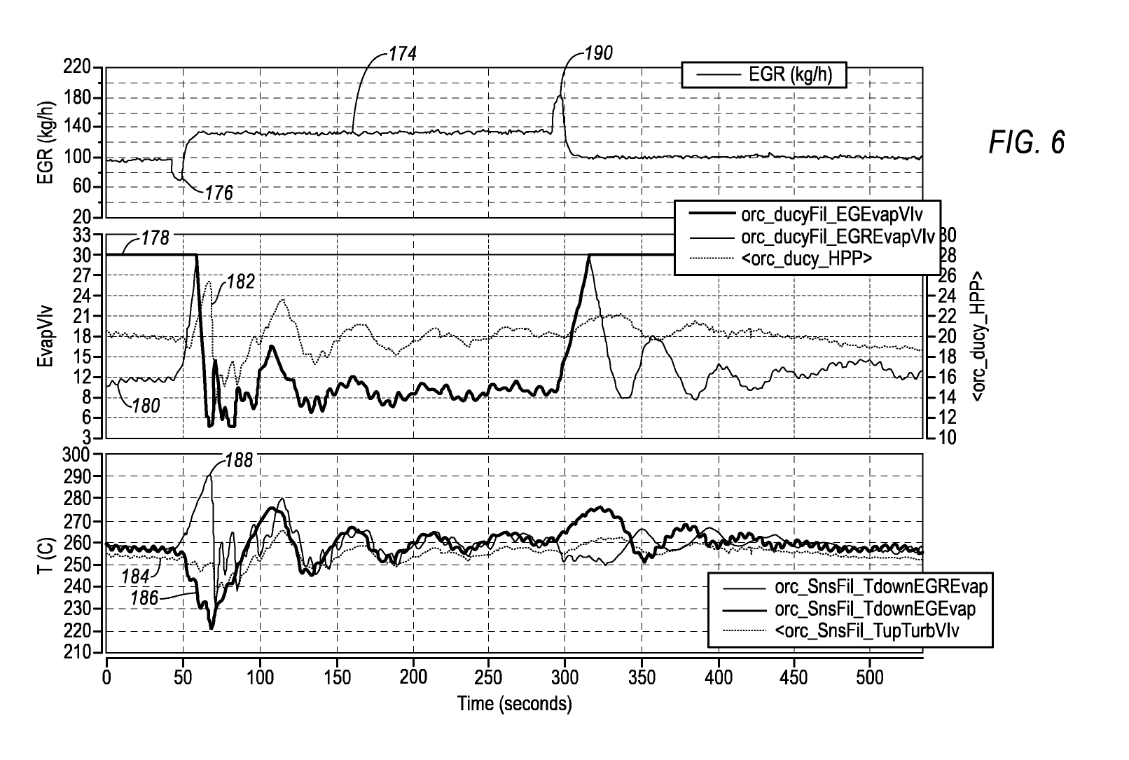

As noted above, it is desired to eliminate instrumentation-dependent data time lags that may result in processing discontinuities. One such discontinuity may arise from the use of CO₂ measurement of the air in the intake manifold to calculate a percentage of the intake air that the EGR constitutes. The EGR percentage as a function of milliseconds of time is illustrated in FIG. 5 by plot 170. This method results in the EGR percentage plot 170 lagging both the real-time EGR and the measured fresh air 37 intake by as much as a few seconds. The discontinuity is particularly noticeable when a CO₂ analyzer that is spaced some distance from the engine performs the CO₂ measurement. For example, if the CO₂ analyzer is connected to the monitored location by a small diameter tube, there can be an appreciable gap in time between when a change in the CO2 content occurs at a monitored location and when the change is detected by the analyzer. The measured fresh air 37 intake is plotted by plot 172 in kg/hr as a function of time in milliseconds. A lag in time of EGR plot 170 relative to Fresh Air plot 172 is readily apparent. As a result of the above-described time lag, a calculated volumetric rate of EGR mass flow plot 174 plotting kg/hr or EGR flow as illustrated in FIG. 6, shows a momentary decrease when the actual EGR flow does not so drop. As also shown in FIG. 6, the perceived momentary drop or negative spike 176 in EGR at the EGR transition point results in a system response to the perceived drop. The system response, although eventually damped, induces significant oscillations in the control of valve 84, illustrated by plot 178 labeled orc_ducyFil_EGEvapVlv, and valve 86, illustrated by plot 180 labeled orc_ducyFil_EGREvapVlv, and pump 32, illustrated by plot 182, labeled orc_ducy_HPP. Consistent with the variations in valve and pump signals, the system temperatures including the temperature measured by sensor 94 and the temperatures at the exits of evaporators 16 and 20 used by sensor 92 to determine the delta temperature experience some significant oscillations. Plot 184, labeled orc_SnsFil_TupTurbVlv, illustrates the temperature variation measured by sensor 94. Plots 186 and 188, labeled orc_SnsFil_Tdown EGEvap and orc_SnsFil_Tdown EGREvap respectively, illustrate temperatures of exhaust gas exiting the tailpipe evaporator and the EGR evaporator respectively. The difference between plots 186 and 188 is equivalent to the delta temperature that is detected by sensor 92. Plot 184 exhibits a peak as much as 15° C. above the target and valleys as much as 25° C. below the target. The same phenomenon occurs when the EGR decreases, but in the opposite direction. That is, when the EGR actually decreases, there is a non-existent spike 190 in EGR that is perceived. This also results in significant oscillations that are eventually damped. While one solution to reduce the time gap is to move the CO2 analyzer closer to the monitored location, an alternative solution is described below.

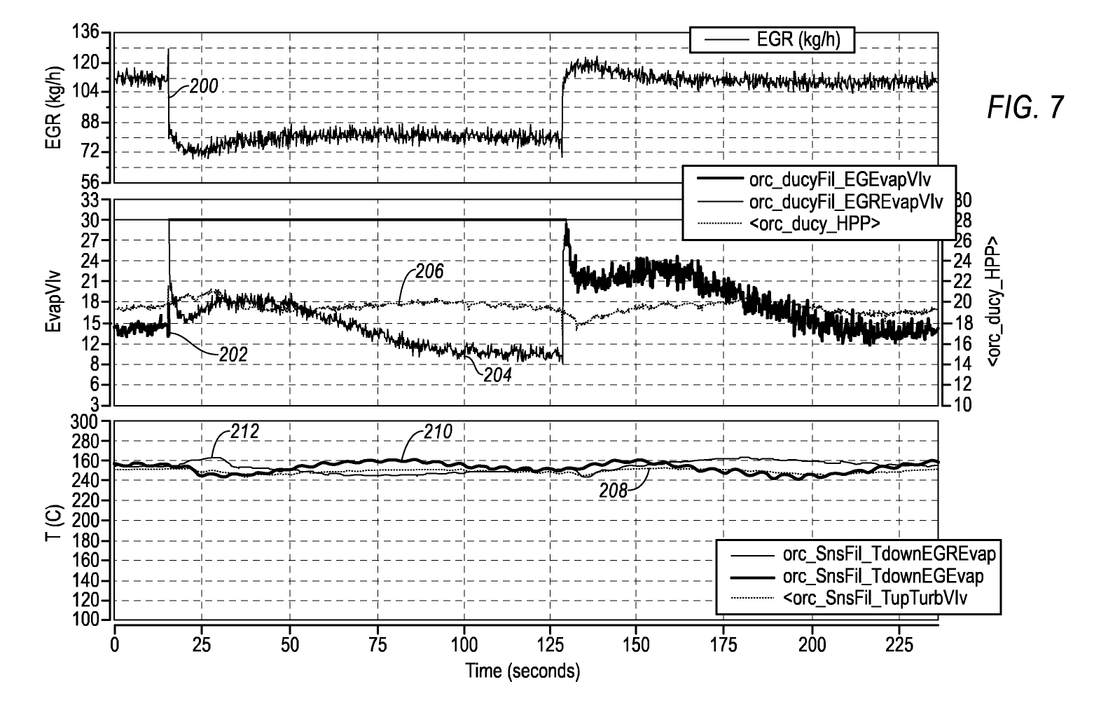

FIG. 7 illustrates the performance of a system in which the perceived EGR lag is substantially eliminated by calculating an estimated value of EGR mass flow and using the value so calculated instead of the value based on the level of CO₂ in the intake manifold. The EGR spikes 176 and 190 have been substantially eliminated.

The EGR percentage rate may be calculated as:

EGR rate=100*EGR flow/(EGR flow+Fresh Air Mass Air Flow)=100*(Engine inlet flow−Fresh Air Mass Air Flow)/Engine inlet flow Equation 12:

Engine inlet flow in liters/hour for a four stroke engine may be calculated as:

Engine inlet flow=Volumetric Efficiency*Engine displacement per cylinder*(P/(R*T))*Engine Speed*(60 minutes/hr)*No. of Cylinders/2, where Equation 13:

Engine displacement per cylinder is in Liters;
P=Pressure in the intake manifold;

### R=Gas Constant;

T=temperature in the intake manifold;
Engine Speed is in revolutions per minute; and
No. of Cylinders is number of active cylinders receiving air.

FIG. 7 plots, 200, 202, 204, 206, 208, 210, 212, reflect the control of the temperature of working fluid 15 with the EGR flow rate derived using equations 12 and 13. The plot 200 of the volumetric rate of EGR mass flow, illustrated in FIG. 7, occurs essentially simultaneously as the change in fresh air, avoiding the spikes 176 and 190 of FIG. 6. The system response is optimally damped without undue oscillations in the control of valve 84, illustrated by plot 202 labeled orc_ducyFil_EGEvapVlv, and valve 86, illustrated by plot 204 labeled orc_ducyFil_EGREvapVlv, and pump 32, illustrated by plot 206, labeled orc_ducy_HPP. Consistent with the valve and pump signals, the system temperatures including the temperature measured by sensor 94, and the temperatures at the exits of evaporators 16 and 20 provided by sensors 92 and 93 to determine the delta temperature, demonstrate remarkably stable values. Plot 208, labeled orc_SnsFil_TupTurbVlv, illustrates the temperature variation measured by sensor 94. Plots 210 and 212, labeled orc_SnsFil_TdownEGEvap and orc_SnsFil_TdownEGREvap respectively, illustrate temperatures of exhaust gas exiting the tailpipe evaporator and the EGR evaporator respectively. The difference between plots 210 and 212 is equivalent to the delta temperature that is detected by sensor 92. Plot 208 stays within a band around the target of approximately 20° C.

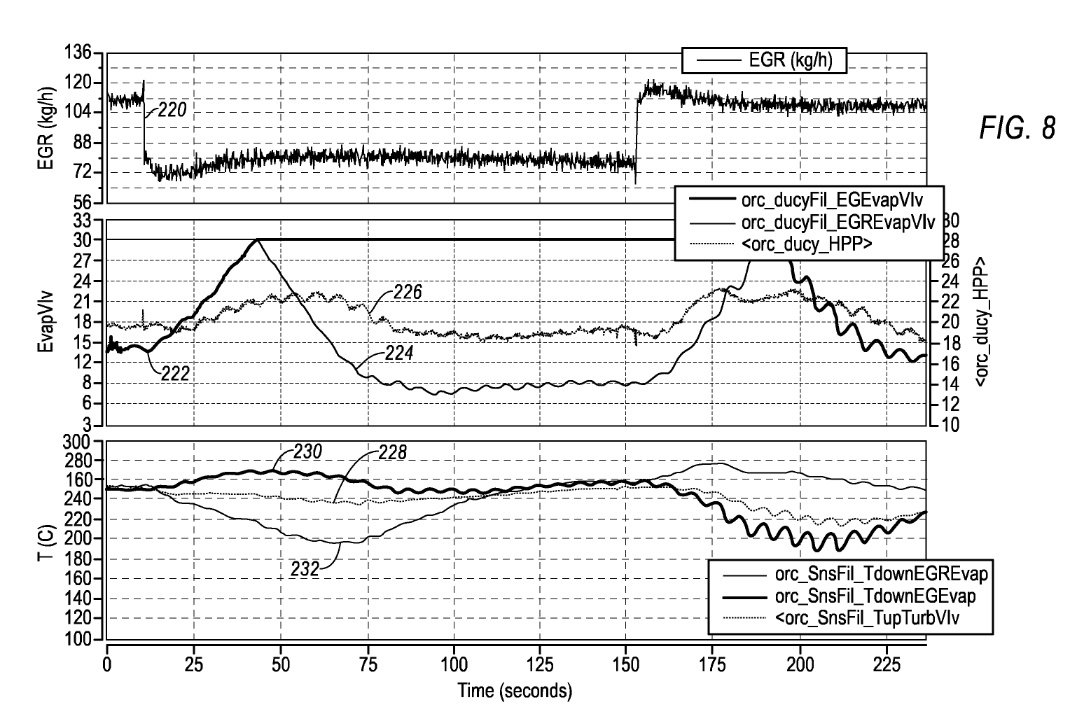

FIG. 8 plots, 220, 222, 224, 226, 228, 230, 232, reflect the control of the temperature of working fluid 15 with the EGR flow rate derived using equations 12 and 13, like FIG. 7, but without feedforward control. The plot 220 of the volumetric rate of EGR mass flow of FIG. 8 is substantially the same as plot 200 in FIG. 7. Without feedforward control, the system response is much slower, with valves 84 and 86 transitioning more gradually than with the system of FIG. 7. For example, when the EGR flow rate in FIG. 7 was decreased, valve 86 was almost immediately adjusted in a step-like fashion to reduce the flow across evaporator 20, and valve 84 was substantially simultaneously opened in a step-like fashion to increase the flow across evaporator 20. By contrast, in FIG. 8, as illustrated by plot 222, valve 84 was opened more gradually, linearly ramping up to a maximum flow condition in approximately 25 seconds. At substantially the same time that plot 222 reached a maximum flow condition, a plot of the setting of valve 86 controlling flow of working fluid 15 through evaporator 20 decreases substantially linearly for approximate 25 seconds. Similarly, when the portion of exhaust gas being diverted for EGR is increased, valve 86 is gradually opened and valve 84 is gradually moved to a more restrictive setting as exhibited by plots 222 and 224. A plot 226 of the pump control signal 226 shows significantly greater variation than the corresponding plot 206 of FIG. 7. Consistent with the variations in valve and pump signals, the system temperatures including the temperature measured by sensor 94 and the temperatures at the exits of evaporators 16 and 20 used by sensor 92 to determine the delta temperature experience some significant oscillations. Plot 228, labeled orc_SnsFil_TupTurbVlv, illustrates the temperature variation measured by sensor 94. Plots 230 and 232, labeled orc_SnsFil_TdownEGEvap and orc_SnsFil_TdownEGREvap respectively, illustrate temperatures of exhaust gas exiting the tailpipe evaporator and the EGR evaporator respectively. The difference between plots 230 and 232 is equivalent to the delta temperature that is detected by sensor 92. Plot 228 stays within a band of around the target of approximately 40° C.

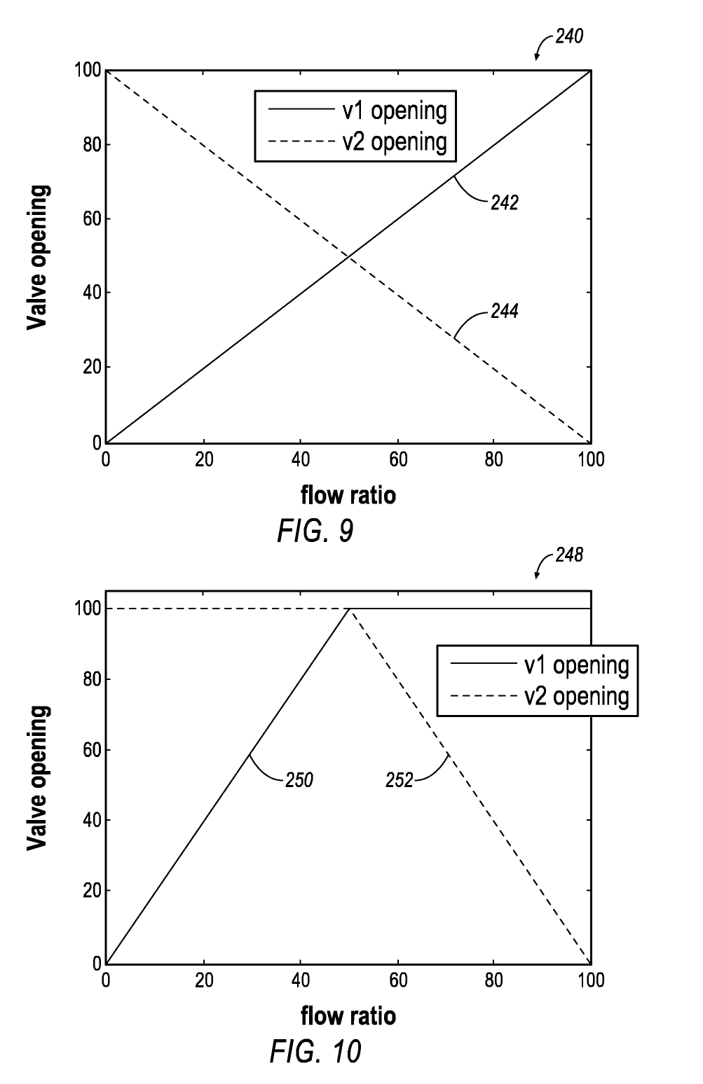

FIGS. 9, 10, and 11 provide additional detail on how inputs 160 and 162 to valves 84 and 86 are generated by process block 152 based on input 158. Process block 152 maps input 158 to the valve opening settings of valves 84 and 86, which split a distribution of working fluid 15 from pump 32 for allocation to evaporators 16 and 20. As described above, input 158 is generated by process block 150, which, in part, sums input 156 from PID feedback process block 146 and input 157 from feedforward process block 148. Each of FIGS. 9, 10, and 11 provides a graph 240, 248, and 256 illustrating for each of valves 84 and 86 an exemplary relationship of selectable valve opening settings, labeled on the vertical axis as “valve opening”, as a function of a flow ratio. The “valve opening” dimension has no units, representing a percentage of the available flow area of each of valves 84 and 86 in a wide-open condition. The “flow ratio” is a ratio of the mass flow rate of the working fluid passing through valve 1, valve 84 being an exemplary valve 1, to the total mass flow rate of the working fluid passing through both valves 84 and 86 together. The flow ratio can be expressed as an equation (using the variables from Equation 6):

Flow Ratio=100*\dot{m}_{WF}_{_}_{EG}/\dot{m}_{WF} Equation 14:

FIG. 9 is a graph 240 illustrating a first exemplary valve opening to flow ratio relationship. In exemplary graph 240, a plot 242, labeled “v1 opening” illustrates the valve opening setting of valve 84 for a flow of the working fluid 15 through valve 84 and evaporator 16. The v1 opening 242 increases from zero to 100 as the flow ratio increases from zero to 100. A plot 244, labeled “v2 opening” illustrates the valve opening setting of valve 86 for a flow of working fluid 15 through valve 86 and evaporator 20. The v2 opening 244 decreases from 100 to zero as the flow ratio increases from zero to 100. An exemplary initial set point of valve openings 242 and 244 is 50, or 50% for each which occurs when the flow ratio is 50 or 50%. A collective mass flow rate of working fluid 15 through evaporators 16 and 20 is substantially constant for a system employing graph 240, corresponding to a valve opening value of 100.

FIG. 10 is a graph 248 illustrating a second exemplary valve opening to flow ratio relationship. In exemplary graph 248, a plot 250, labeled “v1 opening” illustrates the valve opening setting of valve 84 for a flow of the working fluid 15 through valve 84 and evaporator 16. The v1 opening 250 increases from zero to 100 as the flow ratio increases from zero to 50 where v1 opening 250 plateaus and remains at a flow ratio of 100. A plot 252, labeled “v2 opening” illustrates the valve opening setting of valve 86 for a flow of working fluid 15 through valve 86 and evaporator 20. The v2 opening 252 starts at 100 and remains there until the flow ratio is 50, at which point the value for the v2 opening drops linearly to zero when the flow ratio is 100. The maximum plateau values of both valve openings 250 and 252 is 100%. Such an arrangement beneficially reduces both flow restriction and pressure drop across valves 84 and 86. An additional benefit of the flow ratio relationship of graph 248 relative to the flow ratio relationship of graph 240 is that, for graph 248, only one of valves 84 and 86 is moving at a time. Interaction of the movement of valves 84 and 86 is thus substantially reduced, and more liner behavior of the delta temperature ΔT_{Evap} and the temperature of working fluid 15 upstream of the turbine T_{upTurbVlv} are achieved responsive to commands from controller 114. An exemplary initial set point of valve openings 250 and 252 is 100, or 100% for each that occurs when the flow ratio is 50 or 50%. A collective mass flow rate of working fluid 15 passing through evaporators 16 and 20 varies with cumulative flow corresponding to combined valve opening positions of 100 to 200 for a system employing graph 248. In such a system, the cumulative valve opening position peak of 200 occurs with the flow ratio equaling 50 and low valve opening position values of 100 occurring with flow ratios of zero and 100.

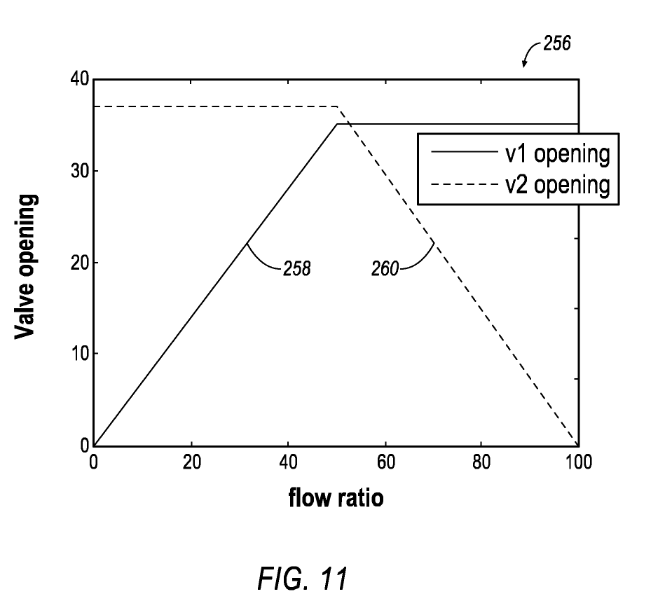

FIG. 11 is a graph 256 illustrating a third exemplary valve opening to flow ratio relationship. Through modeling and testing, it has been discovered that a valve opening of 35% is sufficient to provide the necessary control of temperatures. This may effect the selection of the sizes of valves 84 and 86 based on the size or maximum flow rating of the valves. In exemplary graph 256, a plot 258, labeled “v1 opening” illustrates the valve opening setting of valve 84 for a flow of the working fluid 15 through valve 84 and evaporator 16. The exemplary v1 opening 258 increases from zero to 35 as the flow ratio increases from zero to 50 where it plateaus and remains at a flow ratio of 35. A plot 260, labeled “v2 opening” illustrates the valve opening setting of valve 86 for a flow of working fluid 15 through valve 86 and evaporator 20. The v2 opening 260 starts at 37.5 and remains plateaued there until the flow ratio exceeds 50, at which point the value for the v2 opening drops linearly to zero when the flow ratio is 100. The flow ratio relationship of graph 256 enjoys the benefits of the flow ratio benefits of graph 248. Restricting the valve openings to an opening of less than 50% yields a faster response time, as the valves do not have to fully open. The restriction of the valve openings additionally reduces and potentially eliminates any time that valves 84 and 86 spend in their valve saturation ranges. A valve's saturation range is commonly characterized by no additional flow when additional electrical current is applied to the valve. An exemplary initial set point for valve opening 258 is 35 or 35% and for valve opening 260 is 37.5 or 37.5% that occurs when the flow ratio is 50 or 50%. A collective mass flow rate of working fluid 15 passing through evaporators 16 and 20 varies with valve opening positions of 37.5 to 72.5 to 35 for a system employing graph 256. In such a system, the valve opening position peak of 72.5 occurs with the flow ratio equaling 50 and a first low valve opening position value of 37.5 occurs with a flow ratio of zero and a second low valve opening position value of 35 occurs with a flow ratio of 100. Valves 84, 86 may have a nonlinear relationship between the flow rate and the valve opening. If so, the straight lines illustrated in FIGS. 9-11 will demonstrate some curvature. The curvature can be estimated using valve characteristic data of the selected valves.

### CONCLUSION

A system and method for managing a waste heat recovery system employing two evaporators has been disclosed.

With regard to the references to computers in the present description, computing devices such as those discussed herein generally each include instructions executable by one or more computing devices such as those identified above, and for carrying out blocks or steps of processes described above. For example, process blocks discussed above are embodied as computer executable instructions.

In general, the computing systems and/or devices described may employ any of a number of computer operating systems, including, but by no means limited to, versions and/or varieties of Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance. Examples of computing devices include, without limitation, an on-board vehicle computer, a micro controller, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements may be changed. With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A control system for a vehicle comprising a controller (114), the controller comprising a processor and a memory, the memory storing instructions executable by the processor such that the controller is programmed to:
determine a difference in temperature (ΔT_{Evap}) between a working fluid downstream of a first evaporator (16) and a working fluid (15) downstream of a second evaporator (20);
select a desired flow ratio based on the difference in temperature (ΔT_{Evap});
select a valve opening setting (242, 244, 250, 252, 258, 260) for each of a first valve (84) regulating flow of the working fluid into the first evaporator (16) and a second valve (86) regulating flow of the working fluid into the second evaporator (20) based on the flow ratio;
determine a second temperature (T_{upTurbVlv}) of the working fluid at a second location upstream of a turbine (24) where the working fluid (15) exiting each of the evaporators (16, 20) has blended;
determine a third temperature (T_{downEGREvap}) of the working fluid at a third location downstream of the second evaporator (20);
determine a fourth temperature (T_{downEGEvap}) of the working fluid at a fourth location downstream of the first evaporator (16); and
selectively actuate a pump (32) displacing the working fluid (15) towards the evaporators (16, 20) responsive to a highest of the second temperature (T_{upTurbVlv}), the third temperature (T_{downEGREvap}), and the fourth temperature (T_{downEGEvap}).

2. The system of claim 1, wherein a valve setting (242, 244, 250, 252, 258, 260) for each valve (84, 86) is mapped to the flow ratio.

3. The system of claim 2, wherein the valve setting (242, 250, 258) for the first valve (84) increases with an increase in flow ratio and the valve setting (244, 252, 260) for the second valve (86) decreases with an increase in flow ratio.

4. The system of claim 2, wherein:
the valve setting (250) for the first valve (84) increases with an increase in flow ratio to a first plateau extending from a valve setting at a first flow ratio to a flow ratio of 100 and
the valve setting (252) for the second valve (86) decreases with an increase in flow ratio with the decrease from a second plateau initiating at a second flow ratio.

5. The system of claim 4, wherein the plateaus are valve opening settings below 50.

6. (canceled)

7. The system of claim 1, wherein the controller is further programmed to:
determine a second temperature (T_{upTurbVlv}) of the working fluid at a second location upstream of a turbine (24) where the working fluid exiting each of the evaporators (16, 20) has blended;
determine a third temperature (T_{downEGREvap}) of the working fluid at a third location downstream of the second evaporator (20);
determine a fourth temperature (T_{downEGEvap}) of the working fluid at a fourth location downstream of the first evaporator (16); and
selectively actuate a pump (32) displacing the working fluid (15) towards the evaporators (16, 20) responsive to a highest of the second temperature, the third temperature, and the fourth temperature,
further wherein before a determination is made as to which of the second, third and fourth temperatures are the greatest is made, the third and fourth temperatures are reduced by a value T_{δ}.

8. A method of controlling a waste heat recovery system (10) comprising the steps of:
providing a working fluid circuit (23) including a working fluid (15);
providing a first evaporator (16) in the working fluid circuit;
providing a second evaporator (20) in the working fluid circuit;
providing a first valve (84) in the working fluid circuit in a path of the working fluid entering the first evaporator (16);
providing a second valve (86) in the working fluid circuit in a path of the working fluid entering the second evaporator (20);
providing at least a first temperature sensor (92) in the working fluid circuit to determine a temperature difference (ΔT_{Evap}) between working fluid leaving the evaporators (16, 20);
determining a difference in temperature between the working fluid downstream of the first evaporator (16) and the working fluid downstream of the second evaporator (20);
selecting a desired flow ratio based on the difference in temperature (ΔT_{Evap});
selecting a valve opening setting (242, 244, 250, 252, 258, 260) for each of a first valve (84) regulating flow of the working fluid into the first evaporator (16) and a second valve (86) regulating flow of the working fluid (15) into the second evaporator (20) based on the flow ratio;
determining a second temperature (T_{upTurbVlv}) of the working fluid at a second location upstream of a turbine (24) where the working fluid exiting each of the evaporators (16, 20) has blended;
determining a third temperature (T_{downEGREvap}) of the working fluid at a third location downstream of the second evaporator (20);
determining a fourth temperature (T_{downEGEvap}) of the working fluid at a fourth location downstream of the first evaporator (16); and
selectively actuating a pump (32) displacing the working fluid towards the evaporators (16, 20) responsive to a highest of the second temperature, the third temperature, and the fourth temperature.

9. The method of claim 8, wherein a valve setting (242, 244, 250, 252, 258, 260) for each valve (84, 86) is mapped to the flow ratio.

10. The method of claim 9, wherein the valve setting (242, 250, 258) for a first valve (84) increases with an increase in flow ratio and the valve setting (244, 252, 260) for the second valve (86) decreases with an increase in flow ratio.

11. The method of claim 9, wherein:
the valve setting (250) for the first valve (84) increases with an increase in flow ratio to a first plateau extending from a valve setting at a first flow ratio to a flow ratio of 100 and
the valve setting (252) for the second valve (86) decreases with an increase in flow ratio with the decrease from a second plateau initiating at a second flow ratio.

12. The method of claim 11, wherein the plateaus are valve opening settings (258, 260) below 50.

13. The method of claim 12, wherein the first plateau begins at a flow ratio of 50 and ends at a flow ratio of 100 and the second plateau begins at a flow ratio of zero and ends at a flow ratio of 50.

14. (canceled)

15. The method of claim 8, wherein before a determination is made as to which of the second (T_{upTurbVlv}), third and fourth temperatures (T_{downEGREvap}, T_{downEGEvap}) are the greatest is made, the third and fourth (T_{downEGREvap}, T_{downEGEvap}) temperatures are reduced by a value T_{δ}.
